(19) United States
(12) Patent Application Publication
(10) Pub. No.: US 2013/0031578 A1
(43) Pub. Date: Jan. 31, 2013

(54) SYSTEM AND METHOD FOR CONTROL OF IPTV MULTIMEDIA CONTENT DISTRIBUTION

(71) Applicants: Zhongwen Zhu, Saint-Laurent (CA); Edoardo Gavita, Laval (CA)

(72) Inventors: Zhongwen Zhu, Saint-Laurent (CA); Edoardo Gavita, Laval (CA)

(73) Assignee: TELEFONAKTIEBOLAGET L M ERICSSON (PUBL), Stockholm (SE)

(21) Appl. No.: 13/192,190

(22) Filed: Jul. 27, 2011

(51) Int. Cl. H04N 7/025; H04N 7/18

(52) U.S. Cl. 725/32; 725/82

(57) ABSTRACT

An IPTV filter node in an IPTV network is operative to control the delivery of multimedia content to a plurality of rendering units in a home network by comparison of various multimedia rendering criteria to predetermined subscriber information maintained in a subscriber profile. In some embodiments, the IPTV filter node is further operative to control the delivery of multimedia content via dynamic interaction with an authorization user.

### FIELD OF INVENTION

The present invention relates generally to the control of multimedia content distribution, and in particular to control of home networks in IPTV systems.

### BACKGROUND

Internet Protocol TeleVision (IPTV) is a multimedia content delivery system in which multimedia content is delivered using the architecture and networking methods of the Internet Protocol (IP) suite over a packet-switched network infrastructure, such as the Internet and broadband Internet access networks. IPTV is thus distinguished from traditional television and other multimedia content delivery systems, such as radio frequency broadcast, satellite broadcast, or cable television (CATV) distribution.

IPTV services may be classified into several groups with respect to video content distribution, including live television, time-shifted programming (e.g., rebroadcast or restart of previously distributed content), and video on demand (VOD). Broadly considered, IPTV services may also include other multimedia content, such as games, images, music, and the like.

IPTV is distinguished from general Internet-based or web-based multimedia services by an on-going standardization process, e.g., European Telecommunications Standards Institute (ETSI) and preferential deployment scenarios in subscriber-based telecommunications networks with high-speed access channels into end-user premises via set-top boxes (STB) or other customer-premises equipment.

In many cases, the IP Multimedia Subsystem (IMS) architecture is adopted to support IPTV services in carrier networks. Both the Telecommunication Standardization Sector of the International Telecommunication Union (ITU-T) and ETSI are developing IMS-based IPTV standards (see, e.g., ETSI TS 182 027, the disclosure of which is incorporated herein by reference). This approach has numerous benefits, such as offering carriers the ability to deliver voice, data (e.g., Internet), and IPTV services over the same core infrastructure. Additionally, an IMS-based IPTV system allows for the integration of multimedia content delivery with telephony feature, such as displaying caller ID information for an incoming call on the screen of a rendering unit playing a movie.

The terminal phase of IPTV distribution is often into a home network, which distributes multimedia content from a residential gateway to a plurality of rendering units (e.g., television screens with associated STBs, audio reproduction stations, gaming consoles, or the like). However, there is no way to configure current IPTV systems to autonomously and intelligently control the distribution of content among multiple rendering units in a home network according to a subscriber's preferences. Current IPTV distribution systems stream content to only one rendering unit at a time. If users wish to view or listen to content at more than one rendering unit, it is broadcast within the home network to all rendering units, without any mechanism for restricting the distribution by time, duration, content characteristics (e.g., movie ratings), rendering unit, or the like. Providing a greater degree of control would enhance the user experience, provide a competitive advantage to an IPTV carrier, and increase revenue by encouraging more multimedia content consumption under controlled conditions (e.g., parents may allow content consumption conforming to preapproved parameters when they are not present, as opposed to their current practice of disallowing all access in the face of a complete lack of content control).

### SUMMARY

According to one or more embodiments of the present invention described and claimed herein, an IPTV filter node in an IPTV network is operative to control the delivery of multimedia content to a plurality of rendering units in a home network by comparison of various multimedia rendering criteria to predetermined subscriber information maintained in a subscriber profile. In some embodiments, the IPTV filter node is further operative to control the delivery of multimedia content via dynamic interaction with a subscriber.

One embodiment relates to a method of controlling the distribution of multimedia content to a home network comprising a plurality of rendering units. Each rendering unit is operative to render at least part of the multimedia content to one or more users. The method is performed by a computing machine at a node of an Internet Protocol TeleVision (IPTV) network. A request for multimedia content to be rendered on a first rendering unit of the home network is received from a multimedia application server. A subscriber profile associated with the home network, and including predetermined subscriber information, is retrieved from a database. One or more multimedia rendering criteria are ascertained. The ascertained multimedia rendering criteria are compared with predetermined subscriber information retrieved from the subscriber profile. The home network is controlled to selectively establish a multimedia rendering session between the multimedia application server and a selected rendering unit of the home network, in response to the comparison.

Another embodiment relates to an IPTV filter node in an IPTV network. The node includes a first logical data communication interface operative to communicate with at least one multimedia application server, and a second logical data communication interface operative to communicate with a home network comprising a plurality of rendering units, each operative to render at least part of the multimedia content to one or more users. The node also includes a computing machine in data communication relationship with the first and second data communication interfaces. The computing machine is operative to receive, from a multimedia application server, a request for multimedia content to be rendered on a first rendering unit of the home network; retrieve, from a database, a subscriber profile associated with the home network and including predetermined subscriber information; ascertain one or more multimedia rendering criteria; compare the ascertained multimedia rendering criteria with predetermined subscriber information retrieved from the subscriber profile; and control the home network to selectively establish a multimedia rendering session between the multimedia application server and a selected rendering unit of the home network, in response to the comparison.

### BRIEF DESCRIPTION OF THE DRAWINGS

FIG. 1 is a functional block diagram of an IPTV distribution network and associated networks.

FIG. 2 is a flow diagram of a method of controlling the distribution of multimedia content to a home network by a node of an IPTV network.

FIG. 3 is a signaling diagram depicting signaling for a representative use case in the inventive IPTV network.

FIG. 4 is a functional block diagram of an IPTV filter node

### DETAILED DESCRIPTION

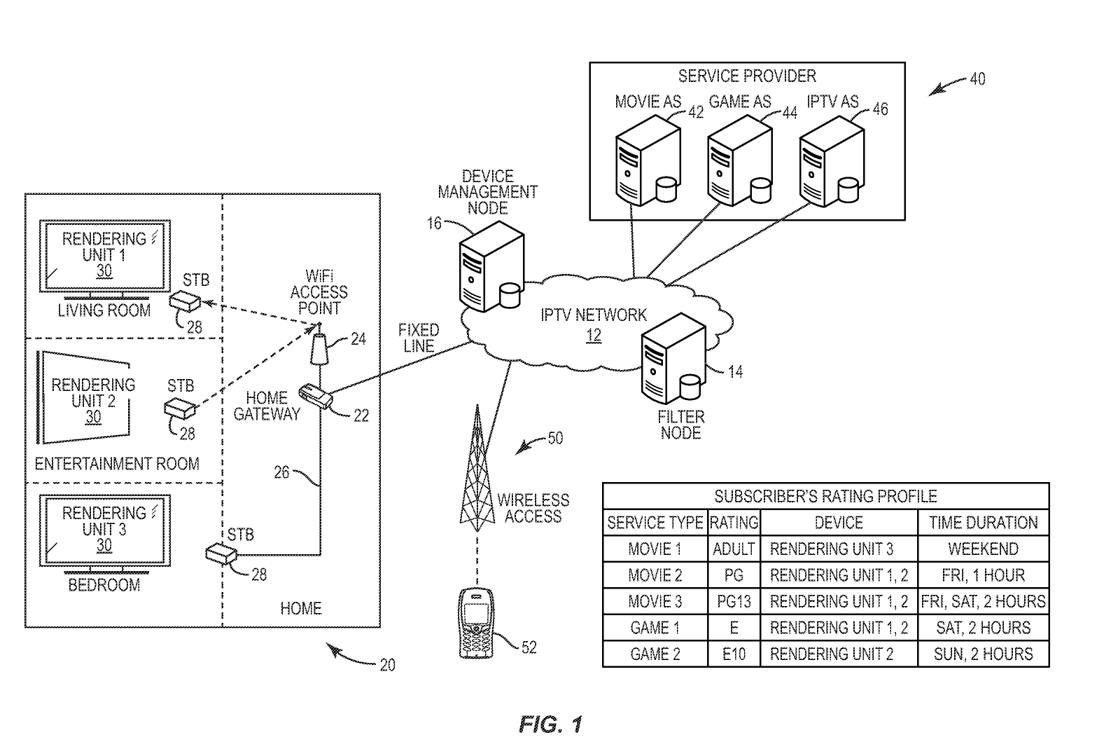

FIG. 1 depicts the architecture of an overall network 10 used for IPTV multimedia content distribution according to embodiments of the present invention. The overall network 10 includes a core IPTV network 12, which may for example comprise a telecommunications services or cable operator network. The IPTV network 12 includes an IPTV filter node 14 and an IPTV device management node 16, both of which are described more fully herein.

The IPTV network is connected to a number of home networks 20, one of which is depicted in FIG. 1. The home network 20 includes a home or residential gateway 22, which may be connected directly, via a wired connection 26, to one or more set top boxes (STB) 28, each associated with a rendering unit 30, such as a television screen. As used herein, a rendering unit 30 is understood to include an associated STB 28 or other networking or control hardware as required for functionality within the IPTV system 10. The wired connection 26 may comprise, e.g., an Ethernet network. Additionally or alternatively, the gateway 22 may connect to a wireless network access point 24, which in turn wirelessly connects to one or more rendering units 30. The wireless network 24 may, for example, comprise an IEEE 802.11x or “Wi-Fi” network.

In general, neither an Ethernet network 26 nor a Wi-Fi network 24 are optimized for the distribution of multimedia content to home network 20 rendering units 30. Wireless networks such as Wi-Fi 24 are optimized for data transmission, but usually do not provide the Quality of Surface (QoS) required by IPTV applications. Wired networks such as Ethernet 26 can achieve the bandwidth and QoS requirements; however, few homes are wired with Ethernet cable 26 to each room in which a rendering unit 30 may be deployed, and retrofitting a house with Ethernet cable 26 is troublesome, expensive, and often unsightly. Networking technologies that take advantage of existing home wiring (such as power lines, telephone line, coaxial cables, and the like) offer a potential solution for the home network 20 portion of an IPTV system 10. For example, in 2008, ITU-T adopted Recommendation G.hn (also known as G.9960), which is a home networking standard that specifies common PHY/MAC layers that can operate over any home wiring. The disclosure of G.9960 is incorporated herein by reference. FIG. 1 depicts both a wired network 26 and a wireless network 24 as representative examples only. Embodiments of the present invention are not limited to either wired, wireless, or hybrid wired/wireless network technology, but rather are applicable to any home network 20 technology operative to selectively distribute IPTV multimedia content from a home gateway 22 to applicable rendering units 30.

FIG. 1 additionally depicts a service provider network 40 comprising a plurality of Application Servers (AS) 42, 44, 46. In particular, the service provider network 40 may include (but is not limited to) a movie or VoD AS 42, a game AS 44, and an IPTV AS 46. Of course, the service provider network 40 may include additional ASs as required or desired. Although depicted as a separate network 40, those of skill in the art will understand that in various embodiments, the service provider network 40 may be integrated with the IPTV network 12.

FIG. 1 further depicts a wireless radio access network (RAN) 50, such as the 3GPP Long Term Evolution (LTE) enhancements to the Universal Mobile Telecommunications System (UMTS). The RAN 50 provides wireless communication services to mobile terminals 52 (also known as mobile stations, cellphones, User Equipment, and the like). In some embodiments of the present invention, the IPTV filter 14 may use the wireless RAN 50 to contact a user associated with mobile terminal 52, such as for IPTV multimedia content distribution authorization, optimization, or customization, as described herein. In other embodiments, connectivity to a wireless RAN 50 is optional or unnecessary. One skilled in the art will appreciate that other radio access technologies can be implemented in RAN 50, such as those based on any one, or combination of Code Division Multiple Access (CDMA), Evolution Data Optimized (EV-DO), Global System for Mobility (GSM), the GSM Packet Radio Service (GPRS), High Speed Packet Access (HSPA) or any other such network.

Although FIG. 1 depicts various network 10 subsystems and entities necessary or useful to practice embodiments of the present invention, those of skill in the art will readily appreciate that the network 10 configuration of FIG. 1 is representative only and not limited. For example, numerous network elements, and indeed entire other networks to which the network 10 may be connected (e.g., the Public Telephone Switching Network, the Internet, various private service provider networks, and the like) are omitted for clarity.

According to embodiments of the present invention, the IPTV filter node 14 performs intelligent, autonomous control of multimedia content distributed not only to the home network 20 of a subscriber, but in fact to each rendering unit 30 of the home network 20, and according to the individual user requesting the content, according to both a predetermined subscriber profile and dynamic, or interactive, commands from an authorized user. The autonomous aspects of control of multimedia content distribution rely on a comparison between various multimedia rendering criteria, predetermined values for the multimedia rendering criteria (and combinations thereof), and predetermined permissions for each individual user, as stored in a subscriber profile.

As used herein, multimedia content refers to information, such as digital information, operative to be rendered into human-perceivable graphic, video, and/or audio form by an appropriate rendering unit. Examples include audio (e.g., music, songs, podcasts, and the like), video (e.g., movies, video clips, animated graphics, and the like), graphics (e.g., images, photographs, graphic art, and the like), games, and interactive software (e.g., social media, groupware, and the like). The term is meant to be construed broadly.

As used herein, multimedia rendering criteria include any parameters by which multimedia content or home network 20 resources may be identified and associated, as well as content- and resource-independent parameters such as temporal point or duration, by which the selective rendering of multimedia content in a home network 20 may be controlled, as well as the identity of individual users. A number of such multimedia rendering criteria are defined, including but not limited to multimedia type classification and rating system values associated with the multimedia content, current use status of home network 20 rendering units 30, temporal points (e.g., day of week and time of day), temporal durations of multimedia sessions, and user identification.

The type classification is an identification of the classification of multimedia content. Examples include movie (VoD), game, real-time stream, music, video clip, and the like.

The rating system for a given type classification is an ordered series of values reflecting a suitability of multimedia content for various classes of users. For example, one movie rating system is published by the Motion Picture Association of America (MPAA), and includes the rating system values General (G), Parental Guidance suggested (PG), Parental Guidance strongly suggested under age 13 (PG-13), Restricted (R), and No Admittance under age 17 (NC-17). As another example, games may be rated according to the Entertainment Software Rating Board (ESRB) game rating system, comprising the rating system values Early Childhood (EC), Everyone (E), Everyone age 10 and older (E10+), Teen (T), Mature (M), and Adults Only (AO). As used herein, a rating system value may include an indication of suitability of multimedia content that may not be part of an “official,” published rating system. As one example, the Recording Industry Association of America (RIAA) publishes “Parental Advisory” warning labels for music having explicit content. Additionally, various proprietary and non-standardized rating systems may be utilized by multimedia content providers or distributors, and of course additional rating systems may be developed in the future.

The current use status of home network 20 rendering units 30, obtained by the IPTV filter node 14 from the home network 20, may be used to make decisions on the rendering unit(s) 30 to which to distribute content. A related criterion is the rendering unit(s) 30 for which certain multimedia content is authorized in the subscriber profile, as described more fully herein.

Temporal reference points, e.g., day of the week and time of day, may be utilized to restrict access to certain multimedia content to certain preapproved times. Additionally, the temporal duration of each multimedia session may be tracked by the IPTV filter node 14. A predetermined temporal duration may be stored in a subscriber profile, which may limit the distribution of multimedia content. For example, a linear IPTV video stream or gaming session may have a predetermined temporal duration limit, such as 30 minutes. When this limit is reached, in various embodiments, the IPTV filter node 14 may terminate the multimedia content distribution, or obtain explicit authorization to extend the content distribution duration.

User ID refers to the discrimination of individual users within a subscription. In general, an IPTV subscription may include a plurality of users. As used herein, a “subscriber” is an individual that opens or is otherwise in control of (e.g., pays for) an IPTV subscription. The subscription may include a plurality of users. The subscriber may designate one or more of the users as an “authorization user.” Only authorization users have permission to alter the subscriber profile, which lists permission criteria for the entire subscription (i.e., all users). In some embodiments, an authorization user may also dynamically alter or extend IPTV content distribution permissions, as described herein. In some embodiments, each user “logs on” to the system, using a unique identification, or user ID, and optionally a password, or in some other way communicates information to the network 12 that identifies the user, or at least discriminates the individual user from among other users under the same subscription.

Of course, the definition and examples listed above for some multimedia rendering criteria do not preclude other criteria that may be advantageously considered in the broad practice of the present invention.

FIG. 1 depicts a representative subscriber profile, containing a plurality of entries defining a representative subscriber's predetermined preferences regarding various combinations of multimedia rendering criteria. For example, the subscriber profile stipulates that a type classification of movie, having a rating system value indicating adult content, should only be delivered to rendering unit 30 number 3 (i.e., located in a bedroom, as indicated by the home network 20 depiction in FIG. 1), and only during the weekend. Additionally, the subscriber profile indicates that movies having ratings of PG or PG-13 may be delivered to rendering units 30 numbers 1 or 2 (i.e., those located in the living room and entertainment room, respectively), with the PG content authorized only on Fridays for one hour, and the PG-13 content authorized on Fridays or Saturdays, for two hours.

The subscriber profile also includes restrictions on other type classifications, such as games. In particular, games having an E rating system value are authorized for rendering units 30 numbers 1 and 2 on Saturdays for two hours, and games having an E-10 rating system value are authorized for rendering unit 30 numbers 2 only, and only on Saturdays, for two hours. Although not depicted in FIG. 1, in one embodiment the subscriber profile may further restrict content by individual user. For example, “user 1” may have access to a certain level or rating of content at a particular rendering unit at a particular time, while “user 2” may be restricted from that level or rating, at the same place and time. Of course, a subscriber profile may include many other combinations of multimedia rendering criteria, to reflect the multimedia content delivery restrictions and authorizations desired by particular subscriber. In some embodiments, this entire profile may include “default” criteria, such as G movies being authorized for all rendering units 30 at any time (default criteria not shown in FIG. 1).

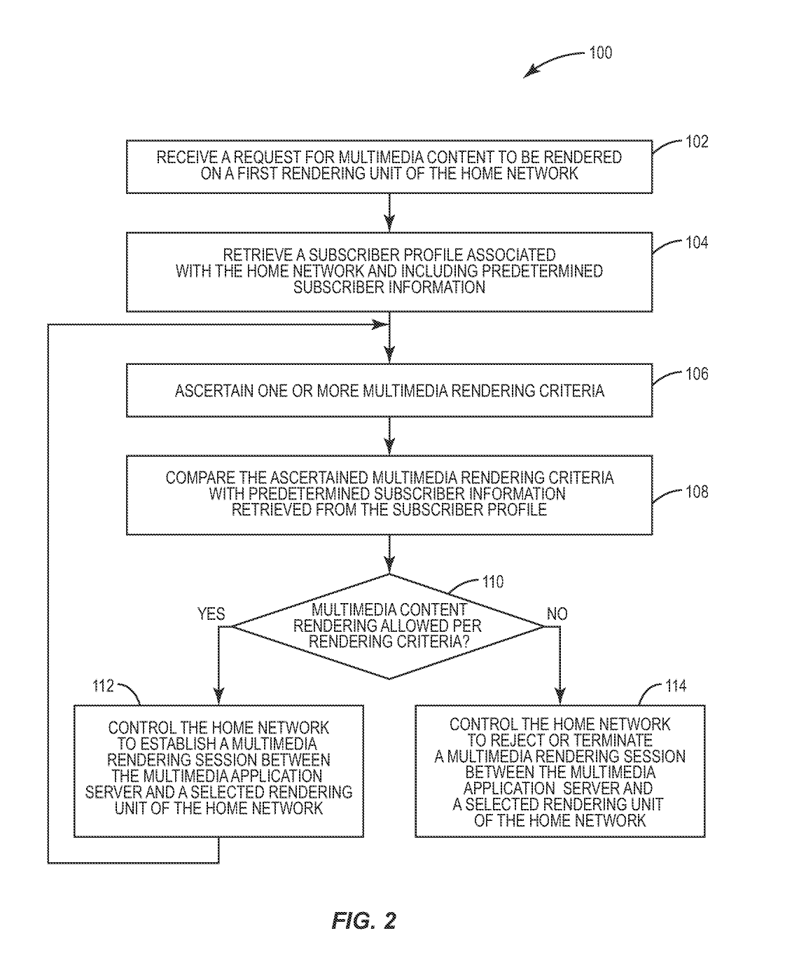

In operation, a user initiates interaction with the IPTV content distribution system by placing a multimedia content access request to a multimedia content server 42, 44, 46. This request may be made conventionally, through a rendering unit 30 (i.e., via a STB 28). Alternatively, the request may be made by other means, such as through an Internet web site via a browser running on an Internet-connected computer, smartphone, or other platform; through a smartphone application (“app”) that facilitates such requests; or any other known or emerging means. In one embodiment, the request includes (or follows) a “log on” procedure by which the individual user is identified, or otherwise informs the network 12 of the requesting user's identity. Regardless of how the request is made, it is received by an appropriate multimedia content server 42, 44, 46, which then requests authorization from the IPTV filter node 14. The IPTV filter node 14 controls the distribution of multimedia content to the home network 20 according to the method 100 depicted in FIG. 2.

The IPTV filter node 14 receives from the multimedia content server 42, 44, 46, a request for multimedia content to be rendered on a first rendering unit 30 of the home network 20 (block 102). The IPTV filter node 14 retrieves a subscriber profile associated with the home network 20, and including predetermined subscriber information, from a database (block 104). In one embodiment, the subscriber profile database is maintained in the device management node 16 of the IPTV network 12 (see FIG. 1).

The IPTV filter node 14 ascertains one or more multimedia rendering criteria (block 106). Some multimedia rendering criteria, such as the multimedia content type (i.e., movie, game, or the like) and rating system value associated with the multimedia content (i.e., PG-13 or R for a movie; E-10 or T for a game, or the like), maybe obtained from the multimedia content server 42, 44, 46, such as within the multimedia content delivery request. Other multimedia rendering criteria, such as temporal points (i.e., day of the week; time of day) or the duration that a multimedia rendering session has been ongoing, are determined independently, such as by reference to a calendar, real-time clock, or various internally-maintained session duration timers. A user ID may be obtained as part of the content request, as described above.

Regardless of how the multimedia rendering criteria are ascertained (block 106), the IPTV filter node 14 compares the rendering criteria with predetermined subscriber information retrieved from the subscriber profile (block 108). Based on this comparison, the IPTV filter node 14 makes various decisions regarding the establishment or termination of a multimedia rendering session between the requesting multimedia application server 42, 44, 46 and one or more rendering units 30 of the home network 20 for a particular user. First, the IPTV filter node 14 determines whether the requested multimedia rendering is allowed (block 110), such as by comparing the rating system value of the requested content and temporal points, such as the day or time, with the information retrieved from the subscriber profile.

If the multimedia content may be distributed, the IPTV filter node 14 compares the requesting rendering unit 30 to the rendering units 30 authorized for that rating of content, date, and time (and possibly other relevant criteria, including the identity of the requesting user), and may allow the multimedia rendering session, either to the requested rendering unit 30 or a different rendering unit 30 in the home network 20 (block 112). Alternatively, the IPTV filter node 14 may reject a requested multimedia rendering session as falling outside of predetermined, approved combinations of multimedia rendering criteria in the subscriber profile (block 114). Additionally, the IPTV filter node 14 may terminate a previously approved multimedia rendering session, if it no longer meets the multimedia rendering criteria—for example, if a predetermined temporal duration of the session has expired (block 114). The IPTV filter node 14 continues to monitor approved multimedia rendering sessions, e.g., for approved temporal duration expiration, as indicated by the flow from block 112 to block 106.

In some embodiments, the IPTV filter node 14 may take further actions to more dynamically control the distribution of multimedia content to the home network 20, such as establishing real-time contact with one or more authorization users. For example, if a requested multimedia rendering session is denied, or an approved multimedia rendering session approaches or reaches its maximum preapproved temporal duration, the IPTV filter node 14 may contact an authorization user via the wireless RAN 50. For example, in one embodiment, the IPTV filter node 14 may send a Short Message Service (SMS, or “text”) message to a authorization user's mobile terminal 52, informing him or her of the requested or expiring multimedia rendering session, and requesting explicit (further) authorization. In one embodiment, one response option may be to open a communication session dialog with the user of the requesting rendering unit 30 and the authorization user, to discuss the contemplated approval or continuation of the multimedia rendering session.

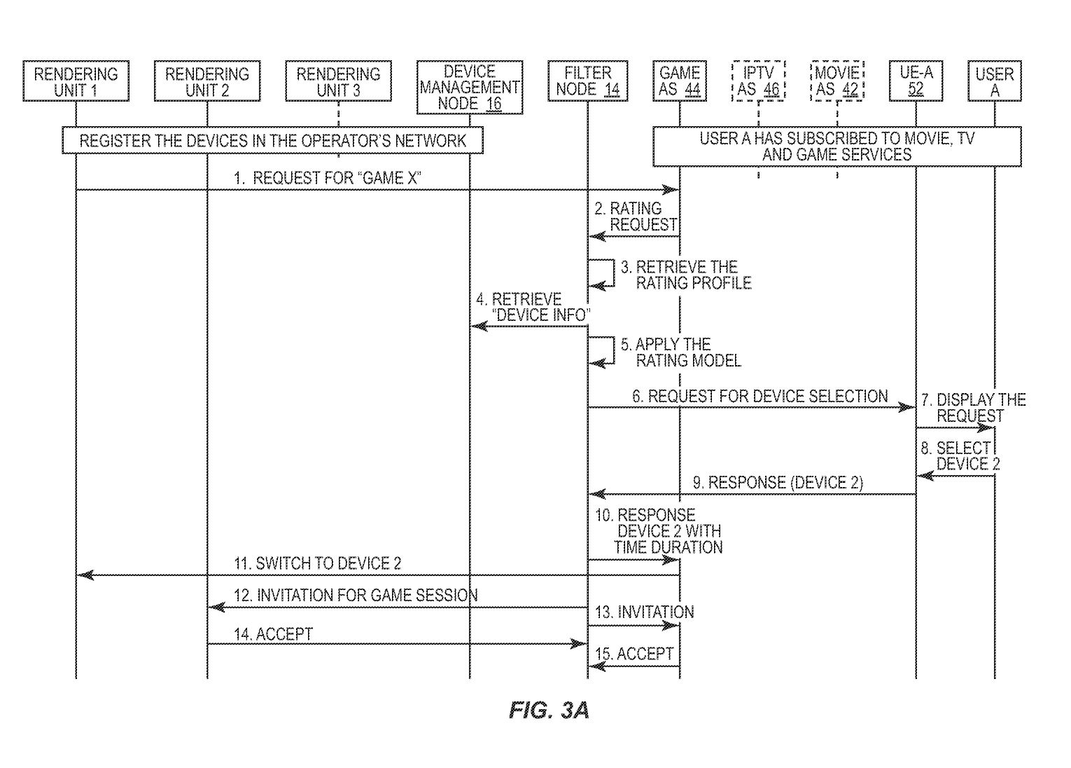

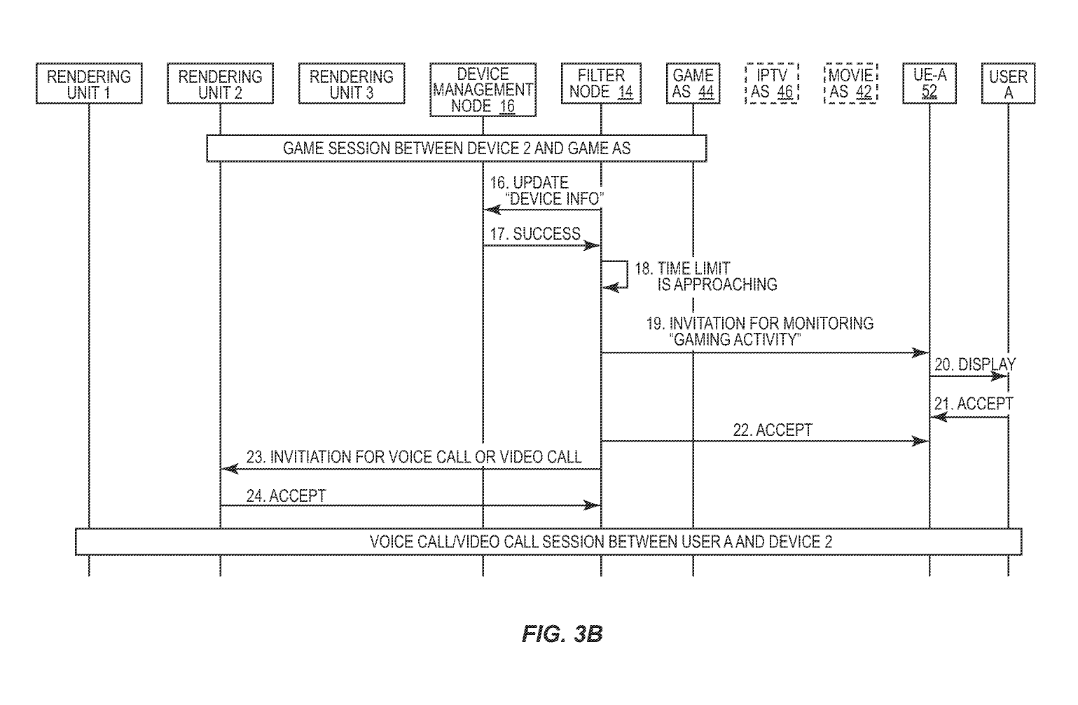

FIG. 3 depicts the detailed steps in one representative use case, which demonstrates several of the options and possible actions of the IPTV filter node 14. This particular use case involves a user requesting a gaming session, initial approval of the gaming session on an approved rendering unit 30 other than that on which it was requested, expiration of a preapproved temporal duration, and establishment of a communication session to discuss extending authorization.

Initially, the authorization user has registered a plurality (e.g., three, as depicted) rendering units 30 with the IPTV system 10, and has subscribed to, e.g., movies, TV streams, and game services. The system interactions are described below with numbers corresponding to the signals flows in FIG. 3.

1. A user, for example, the subscriber's child, requests a gaming session, such via a traditional selection from an on-screen menu on rendering unit 30 number 1. The request is routed by conventional means (e.g. through HTTP (IP) or IMS network) to the game AS 44.

2. The game AS 44 sends a request to the IPTV filter node 14. The request includes the type classification of “game,” and a rating system value, such as “T.”

3. The IPTV filter node 14 retrieves the subscriber profile from a database. Although depicted as residing in the IPTV filter node 14, the database could reside in a different network 12 node, with signaling as appropriate.

4. The IPTV filter node 14 retrieves device information associated with the subscriber (i.e., information about the home network 20) from the IPTV device management node 16. In some embodiments, the IPTV device management node 16 maintains a running, current status of the use state of devices in the home network 20, or queries the home network 20 for the current use state of devices (not shown).

5. The IPTV filter node 14 applies the information from the subscriber profile, comparing it against the ascertained multimedia rendering criteria.

6. In this example, the requesting rendering unit 30 is not authorized for the applicable type classification, rating system value, temporal points and/or the requesting user, but indicates that an authorization user may or should be contacted for authorization. The IPTV filter node 14 then directs a message to authorization user's mobile terminal 52, relaying the gaming session request.

7. The authorization user receives the request.

8. The authorization user responds to the request, selecting parameters that indicate the game session is authorized, but only on rendering unit 30 number 2, and only for one hour. The authorization user further indicates a desire to talk to the requesting user (i.e., the subscriber's child) at the conclusion of the one-hour time limit if he or she desires further game time.

9. The authorization user's mobile terminal 52 relays the response back to the IPTV filter node 14.

10. The IPTV filter node 14 allocates a session object and sends a response to the game AS 44. The response includes access information on the session object and the specified play time (e.g., one hour).

11. The game AS 44 sends a response to rendering unit 30 number 1, with a message such as “switch from device 1 to device 2,” to be displayed to the user.

12. The session object in the IPTV filter node 14 sends an invitation for a gaming session to the rendering unit 30 number 2.

13. The session object in the IPTV filter node 14 also sends an invitation for a gaming session to the game AS 44.

14. Rendering unit 30 number 2 accepts the invitation and sends a response to the IPTV filter node 14.

15. The game AS 44 accepts the invitation and sends a response to the IPTV filter node 14.

A gaming session is established between the game AS 44 and the rendering unit 30 number 2, via the session object in the IPTV filter node 14.

16. The IPTV filter node 14 updates the IPTV device management node 16 with the current use status of rendering unit 30 number 2.

17. The IPTV device management node 16 responds with a success message.

18. The IPTV filter node 14 continues to monitor multimedia rendering criteria—in particular, it measures the elapsed temporal duration of the gaming session. In this example, the IPTV filter node 14 detects that the one-hour temporal duration limit is approaching.

19. As requested in the response at step 8 above, and since the user is still playing the game, the IPTV filter node 14 sends a request to the authorization user's mobile terminal 52 for a conference.

20. The authorization user receives the request.

21. The authorization user responds to the request, accepting the conference.

22. The authorization user's mobile terminal 52 relays the acceptance to the IPTV filter node 14.

23. The IPTV filter node 14 sends an invitation to the user via rendering unit 30 number 2, which may display the invitation on the screen.

24. The user accepts the invitation for a conference.

The authorization user and the gaming user then engage in a voice and/or video call session, during which the user may negotiate to extend the game session. Although not explicitly depicted in FIG. 3, at the conclusion of the conference, the authorization user will relay to the IPTV filter node 14 the extended game session temporal duration, and possibly additional multimedia rendering criteria, and signaling similar to steps 8-18 will occur.

Of course, the above use case depicts only one example of the rich and varied control which embodiments of the present invention provide for controlling many aspects of multimedia content delivery to a home network 20.

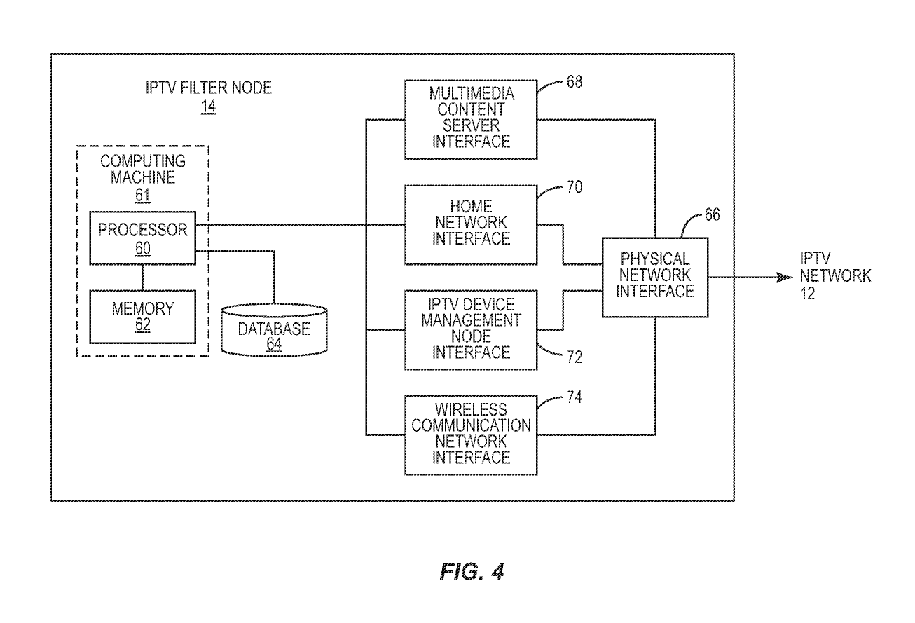

FIG. 4 depicts a functional block diagram of one embodiment of the IPTV filter node 14. The IPTV filter node 14 includes a processor 60, operatively connected to memory 62 and a data base 64. The processor 60 is connected to at least one physical network interface 66. A plurality of logical interfaces 68, 70, 72, 74, shown as interposed between the processor 60 and the physical network interface 66, operative to format messages to and from the various networks and nodes with which the IPTV filter node 14 communicates.

The processor 60, together with the memory 62, comprises a computing machine 61 operative to perform the at least the steps of the method 100 described herein. The processor 60 may comprise a hardware state machine; a programmable logic array with appropriate firmware; a microprocessor or digital signal processor (DSP) with appropriate software; or any combination thereof. The memory 62 may comprise solid state memory (e.g., ROM, DRAM, Flash, and the like), and/or a device capable of reading computer-readable media, such as optical or magnetic media. The database 64 may comprise any structure or circuit operative to store and retrieve ordered fields of data. In particular, the database 64 is operative to store and retrieve a plurality of subscriber profiles, each containing predetermined subscriber information, such as predetermined values for multimedia rendering criteria. In some embodiments, the database 64 may reside on the IPTV network 12, outside of the IPTV filter node 14.

The logical interfaces 68, 70, 72, 74 may comprise physical circuits, or alternatively may comprise functional software modules executed by the processor 60. A multimedia content server interface 68 is operative to format messages to and from the service provider network 40 (i.e., the movie AS 42, game AS 44, and/or IPTV AS 46). A home network interface 70 is operative to format messages to and from the home network 20. An IPTV device management node interface 72 is operative to format messages to and from the IPTV device management node 16. A wireless communication network interface 74 is operative to format messages to and from the wireless RAN 50. As will be readily appreciated by those of skill in the art, two or more of the interfaces 68, 70, 72, 74 may be combined. Similarly, one, some, or all of the interfaces 68, 70, 72, 74 may include the necessary components of physical network interface 66, and hence directly connect to one or more components external to the IPTV filter node 14.

In general, the IPTV filter node 14 may physically comprise a network-connected “server” computer, as known in the art, configured with appropriate software to implement an IPTV filter node 14 according to embodiments disclosed herein. As well known in the art, such a computer includes numerous components (e.g., power supply, backup storage, human interface components, and the like) not directly relevant to an explication of embodiments of the present invention, and hence excluded from the drawing figures for clarity.

Embodiments of the present invention enable a degree of control over multimedia content delivery to a home network 20 unknown in the prior art. In particular, the degree of control, and the division between predetermined control parameter stored in a subscriber profile and dynamic, interactive control between the IPTV filter node 14 and the subscriber (or other authorized person), represent a significant advancement in the state of the art of multimedia content delivery and control.

Embodiments of the present invention allow subscribers and their designated authorization users (e.g., parents) to control the delivery of multimedia content in their homes, according to numerous criteria. The authorization users may control the specific rendering units 30 within a home network 20 to which multimedia content may be delivered. The authorization users may also control the multimedia content according to type and rating system value, as well as temporal points (day of week; time of day), duration, and requesting user ID. Due to this rich matrix of control parameters, authorization users may allow for the delivery of multimedia content in their absence, e.g., for consumption by minors, when absent such control, they would simply disallow all multimedia content delivered. Accordingly, service providers deploying IPTV multimedia content delivery control according to embodiments of the present invention may realize significant additional content access and hence enhanced revenues.

The method 100 of embodiments of the present invention may be implemented as one or more software modules operative to cause one an appropriately-configured computing machines 61 to perform the defined method steps. Such software may be stored as program code on nontransient computer-readable media, such as optical media (e.g., CD-ROM, DVD), magnetic media (e.g., hard disc drive or floppy disc), solid state memory (e.g., ROM, PROM, Flash memory), or the like, as known in the art. In some embodiments, the software may be transmitted as transient signals via a data communication network, such as the Internet. In any case, the software is operative to transform an appropriately-configured computing machine 61 into a novel, nonobvious, inventive machine operative to perform at least the method 100.

The present invention may, of course, be carried out in other ways than those specifically set forth herein without departing from essential characteristics of the invention. Various features and elements can be combined in with each other in a variety of ways as will be appreciated by those skilled in the art without departing from the scope of the present invention. The present embodiments are to be considered in all respects as illustrative and not restrictive, and all changes coming within the meaning and equivalency range of the appended claims are intended to be embraced therein.

What is claimed is:

1. A method of controlling the distribution of multimedia content to a home network comprising a plurality of rendering units, each operative to render at least part of the multimedia content to one or more users, the method performed by a computing machine at a node of an Internet Protocol TeleVision (IPTV) network, the method comprising:
receiving, from a multimedia application server, a request for multimedia content to be rendered on a first rendering unit of the home network;
retrieving, from a database, a subscriber profile associated with the home network and including predetermined subscriber information;
ascertaining one or more multimedia rendering criteria;
comparing the ascertained multimedia rendering criteria with predetermined subscriber information retrieved from the subscriber profile; and
controlling the home network to selectively establish a multimedia rendering session between the multimedia application server and a selected rendering unit of the home network, in response to the comparison.

2. The method of claim 1 wherein ascertaining one or more multimedia rendering criteria comprises receiving one or more multimedia rendering criteria from the multimedia application server.

3. The method of claim 2 wherein the multimedia rendering criteria comprises at least one of a type classification of the multimedia content and a rating system value associated with the multimedia content.

4. The method of claim 1 wherein the multimedia rendering criteria comprises at least one of an identification of the requesting user and a temporal duration of the multimedia rendering session.

5. The method of claim 1 wherein ascertaining one or more multimedia rendering criteria comprises receiving, from the home network, a current use status of one or more rendering units of the home network.

6. The method of claim 1 wherein the subscriber profile comprises one or more entries, each entry comprising predetermined subscriber information associating one or more rendering units of the home network with one or more predetermined values of multimedia rendering criteria.

7. The method of claim 1 wherein controlling the home network to selectively establish a multimedia rendering session between the multimedia application server and a selected rendering unit of the home network comprises transmitting directives to one or more rendering units to establish, continue, or terminate a multimedia rendering session with the multimedia application server.

8. The method of claim 1 wherein controlling the home network to selectively establish a multimedia rendering session between the multimedia application server and a selected rendering unit of the home network comprises terminating a multimedia rendering session between the multimedia application server and the first rendering unit of the home network.

9. The method of claim 8 further comprising establishing a multimedia rendering session between the multimedia application server and a second rendering unit of the home network.

10. The method of claim 1, further comprising:
contacting an authorization user; and
wherein controlling the home network to selectively establish a multimedia rendering session in response to the comparison further comprises controlling the home network to selectively establish or continue the multimedia rendering session in response to input from the authorization user.

11. The method of claim 10 wherein contacting the authorization user further comprises establishing a communication session between a user via the home network and the authorization user.

12. An IPTV filter node in an Internet Protocol TeleVision (IPTV) network, comprising:
a first logical data communication interface operative to communicate with at least one multimedia application server;
a second logical data communication interface operative to communicate with a home network comprising a plurality of rendering units, each operative to render at least part of the multimedia content to one or more users; and
a computing machine in data communication relationship with the first and second data communication interfaces and operative to:
receive, from a multimedia application server, a request for multimedia content to be rendered on a first rendering unit of the home network;
retrieve, from a database, a subscriber profile associated with the home network and including predetermined subscriber information;
ascertain one or more multimedia rendering criteria;
compare the ascertained multimedia rendering criteria with predetermined subscriber information retrieved from the subscriber profile; and
control the home network to selectively establish a multimedia rendering session between the multimedia application server and a selected rendering unit of the home network, in response to the comparison.

13. The IPTV filter node of claim 12 further comprising a third logical data communication interface operative to communicate with a device management node in the IPTV network, and wherein the computing machine is operative to ascertain one or more multimedia rendering criteria by obtaining current use state of rendering units in the home network from the device management node.

14. The IPTV filter node of claim 12 wherein the computing machine is operative to ascertain one or more multimedia rendering criteria by receiving one or more multimedia rendering criteria from the multimedia application server.

15. The IPTV filter node of claim 14 wherein the multimedia rendering criteria comprises ate least one of a type classification of the multimedia content and a rating system value associated with the multimedia content.

16. The IPTV filter node of claim 12 wherein the computing machine is operative to ascertain one or more multimedia rendering criteria by receiving, from the home network, a current use status of one or more rendering units of the home network.

17. The IPTV filter node of claim 12 wherein the multimedia rendering criteria comprises at least one of a temporal duration of the multimedia rendering session and an identification of the requesting user.

18. The IPTV filter node of claim 12 wherein the subscriber profile comprises one or more entries, each entry comprising predetermined subscriber information associating one or more rendering units of the home network with one or more predetermined values of multimedia rendering criteria.

19. The IPTV filter node of claim 12 wherein the computing machine is operative to control the home network to selectively establish a multimedia rendering session between the multimedia application server and a selected rendering unit of the home network by transmitting directives to one or more rendering units to establish, continue, or terminate a multimedia rendering session with the multimedia application server.

20. The IPTV filter node of claim 12 wherein the computing machine is operative to control the home network to selectively establish a multimedia rendering session between the multimedia application server and a selected rendering unit of the home network by terminating any multimedia rendering session between the multimedia application server and the first rendering unit of the home network.

21. The IPTV filter node of claim 20 wherein the computing machine is further operative to establish a multimedia rendering session between the multimedia application server and a second rendering unit of the home network.

22. The IPTV filter node of claim 12 wherein the computing machine is further operative to:
contact an authorization user; and
wherein the computing machine is operative to control the home network to selectively establish a multimedia rendering session in response to the comparison by controlling the home network to selectively establish or continue the multimedia rendering session in response to input from the authorization user.

23. The IPTV filter node of claim 22 wherein the computing machine is further operative to contact the authorization user by establishing a communication session between a user via the home network and the authorization user.
